(19) United States
(12) Patent Application Publication
(10) Pub. No.: US 2007/0170611 A1
(43) Pub. Date: Jul. 26, 2007

(54) Start-up procedure for underwater pelletizer

(76) Inventor: Andrew Steven Hudson, White Oak, TX (US)

Correspondence Address: Michael J. Blake;Eastman Chemical Company, P.O. Box 511, Kingsport, TN, 37662-5075, US

(21) Appl. No.: 11/581,616

(22) Filed: Oct. 16, 2006

Related U.S. Application Data
(60) Provisional application No. 60/762,368, filed on Jan. 26, 2006.

(51) Int. Cl. B28B 7/04

(52) U.S. Cl. 264/39; 264/142

(57) ABSTRACT

A method for starting up or stopping and restarting an underwater pelletizer is described. The method involves inducing partial freeze-off of the polymer melt in the holes of an internally insulated die plate to prevent polymer drool by passing full water flow across the face of the die plate. The method advantageously does not require using hot oil to heat the die plate or decreasing and/or increasing the heating provided to the die plate.

### FIELD OF THE INVENTION

The present invention generally relates to an improved method for starting up an underwater pelletizer.

### BACKGROUND OF THE INVENTION

Polymer pellets are usually prepared by extruding a polymer melt through a die plate having a number of holes. Typically, the die plate is submerged in a cooling water bath such that the polymer solidifies as it exits the die plate. As the polymer leaves the die, it is cut into pellets by rotating blade(s) passing over the die face and swept away by a flow of cooling water.

A common method for starting up an underwater pelletizer is to sequence the start-up procedure steps. The sequence involves passing water across the plate die within a few seconds before passing molten polymer through the die plate holes. Sequenced start-ups, however, can be difficult, particularly on larger underwater pelletizers, because the water-flow across the die plate must be timed just right to obtain successful pelletization. Excess drool of the polymer melt before sufficient water is passed across the die plate can lead to poor pellet quality and failed start-up attempts. The reverse is also true. If the water flows across the die plate too long before melt flow is established, the holes can freeze off and operation can be hampered.

To remedy this problem, attempts have been made to start a pelletizer underwater, i.e., with full water-flow across the die plate. However, such attempts have required the use of a hot oil system to heat the die plate to very high temperatures. These hot oil systems are not only expensive, but also pose safety and environmental concerns such as flammability and disposability.

Accordingly, there is a need in the art for a more forgiving, cheaper, safer, more environmentally friendly, and reliable start-up procedure for underwater pelletizers, particularly ones that use steam-heated die plates.

### SUMMARY OF THE INVENTION

A method for successfully starting up a pelletizer with full water-flow across a die plate that is not heated by oil has been surprisingly discovered. Thus, in one aspect, the invention provides a method for starting up a thermoplastic resin pelletizer. The method comprises the steps of:

(a) providing a thermoplastic resin pelletizer having an internally insulated die plate;

(b) heating a thermoplastic resin melt in the pelletizer to a temperature of Tm+30° C. to Tm+200° C., where Tm is the melt transition temperature of the thermoplastic resin as measured by ASTM D-3418;

(c) heating the die plate to a temperature of Tm+50° C. to Tm+250° C.;

(d) passing water having a temperature between Tm−20° C. to Tm−50° C. across the face of the die plate for an amount of time sufficient to solidify at least a portion of the thermoplastic resin melt in the holes of the die plate before extruding the thermoplastic resin melt through the die plate; and

(e) extruding the thermoplastic resin melt through the die plate.

In another aspect, the invention provides a method for stopping and restarting a thermoplastic resin pelletizer having an internally insulated die plate. The method comprising the steps of:

(a) stopping extruding a thermoplastic resin melt through the die plate;

(b) maintaining water flowing across the face of the die plate at a temperature used during extrusion for an amount of time sufficient to solidify at least a portion of the thermoplastic resin melt in the holes of the die plate;

(c) maintaining the thermoplastic resin melt in the pelletizer at a temperature used during extrusion;

(d) maintaining the die plate at a temperature used during extrusion; and

(e) restarting extruding the thermoplastic resin melt through the die plate.

### DETAILED DESCRIPTION OF THE INVENTION

In one aspect, the invention provides a method for starting up a thermoplastic resin pelletizer. The first step of the method involves providing a thermoplastic resin pelletizer having an internally insulated die plate. Any pelletizer capable of extruding a thermoplastic resin material may be used. Internally insulated die plates suitable for use in the invention are known in the art such as those described in U.S. Pat. Nos. 4,752,196 and 4,856,974 and EP 0 246 921; the contents of which are hereby incorporated by reference.

As used herein, the words “extruder,” “extruding,” or “extrusion” are not meant to be limiting. They include all modes of increasing resin melt pressure behind the die plate to push the resin melt through the holes of the die plate. Such modes include single-screw extruders, multi-screw extruders, and positive displacement devices such as gear pumps.

The second step of the method involves heating a thermoplastic resin melt in the pelletizer to a temperature of Tm+30° C. to Tm+200° C., where Tm is the melt transition temperature of the thermoplastic resin as measured by ASTM D-3418. For low density polyethylene (LDPE), for example, which has a Tm of about 110° C., the resin melt should have a temperature ranging from about 230° C. to about 300° C. Preferably, the LDPE melt temperature is about 250° C. For other thermoplastic resins such as linear low density polyethylene (LLDPE), high density polyethylene (HDPE), and polypropylene (PP), the polymer melt temperature can be about 230° C. Other thermoplastic resins are contemplated to be within the scope of the invention such as polyesters.

The third step of the method involves heating the die plate to a temperature of Tm+50° C. to Tm+250° C. The die plate is preferably heated with steam, but other modes of heating are contemplated such as by electric heating elements. For LDPE, for example, the die plate temperature can range from about 225° C. to about 260° C. Preferably, the die plate temperature in the case of LDPE is about 225° C. For other thermoplastic resins such as LLDPE, HDPE, and PP, the die plate temperature can be about 250° C.

Steam is generally available in a typical plant at atmospheric pressure up to 600 pounds per square inch (psi). In the case the die plate is heated with steam, the steam pressure can range from 100 to 600 psi, depending on the desired die plate temperature.

The fourth step of the method involves passing water having a temperature between Tm−20° C. to Tm−50° C. across the face of the die plate for an amount of time sufficient to solidify at least a portion of the thermoplastic resin melt in the holes of the die plate before extruding the thermoplastic resin melt through the die plate. This cooling water can be supplied through the use of a water box that can be fitted over the die plate, as is known in the art. In the case of LDPE, for example, the water can have a temperature of about 60° C. to about 90° C. Preferably, the water temperature is about 75° C. In the case of other thermoplastic resins such as HDPE, LLDPE, and PP, the water temperature can be about 70° C. to about 90° C.

As will be apparent to persons skilled in the art, the time sufficient to solidify at least a portion of the thermoplastic resin melt in the holes of the die plate can vary depending on a number of factors, including the resin composition, melt temperature, die plate temperature, amount of insulation in the die plate, and cooling water temperature and flow rate. Also, the extent of the solidification can vary. The thermoplastic resin in the holes of the die plate should be sufficiently low in viscosity to minimize or prevent polymer drool and cooling water from flowing back into the extruder, but should not be so much that it would create too much back-pressure to restart the polymer melt flow (a condition commonly referred to as “freeze-off”). Generally, this time can be greater than a few seconds such as 5 seconds to several hours or greater. Preferably, the time ranges from 1 minute to 30 minutes, and more preferably from 5 minutes to 25 minutes.

Steps 2-4 can be carried out in any order or simultaneously.

Finally, the extruder in the pelletizer can be started and extruding the thermoplastic resin melt through the die plate can begin.

Through the use of the above-mentioned steps and conditions, it is possible to start a pelletizer with full water flow across the die plate without the use of an oil-heated die plate.

In another aspect, the invention provides a method for stopping and restarting a thermoplastic resin pelletizer having an internally insulated die plate. In a thermoplastic resin pelletizer that is already running, i.e., extruding polymer, the first step in this method involves stopping extrusion of the thermoplastic resin melt through the die plate. Suitable pelletizers, thermoplastic resins, and die plates are as mentioned in the first aspect. This step can be carried out by halting the extruder portion of the pelletizer.

During stoppage of the extruder, the rotating blade(s), which is used to cut extruded polymer melt into pellets, can be maintained rotating or can be stopped.

The second step of this method involves maintaining water flowing across the face of the die plate at a temperature that was used during extrusion for an amount of time sufficient to solidify at least a portion of the thermoplastic resin melt in the holes of the die plate. Preferably, the water is maintained at a temperature of Tm−20° C. to Tm−50° C. across the face of the die plate. This cooling water can be supplied through the use of a water box that can be fitted over the die plate, as is known in the art. In the case of LDPE, for example, the water can have a temperature of about 60° C. to about 90° C. Preferably, the water temperature is about 75° C. In the case of other thermoplastic resins such as HDPE, LLDPE, and PP, the water temperature can be about 70° C. to about 90° C.

Generally, the extruder can be stopped for a few seconds such as 5 seconds to several hours or greater while the cooling water continues to flow across the face of the die plate. Preferably, this time ranges from 1 minute to 30 minutes, and more preferably from 5 minutes to 25 minutes.

The third step in this method involves maintaining the thermoplastic resin melt in the pelletizer at a temperature that was used during extrusion. Typically, a thermoplastic resin melt in the pelletizer can be maintained at a temperature of Tm+30° C. to Tm+250° C., where Tm is the melt transition temperature of the thermoplastic resin as measured by ASTM D-3418. For LDPE, for example, which has a Tm of about 110° C., the resin melt typically has a temperature ranging from about 230° C. to about 300° C. Preferably, the LDPE melt temperature is about 250° C. For other thermoplastic resins such as linear low density polyethylene (LLDPE), high density polyethylene (HDPE), and polypropylene (PP), the polymer melt temperature can be about 230° C.

The fourth step of the method involves maintaining the die plate at a temperature used during extrusion. Typical die plate temperatures range from Tm+50° C. to Tm+250° C. The die plate is preferably heated with steam, but other modes of heating are contemplated such as by electric heating elements. For LDPE, for example, the die plate temperature can range from about 225° C. to about 260° C. Preferably, the die plate temperature in the case of LDPE is about 225° C. For other thermoplastic resins such as LLDPE, HDPE, and PP, the die plate temperature can be about 250° C.

In the case the die plate is heated with steam, the steam pressure can range from 100 to 600 psi, depending on the desired die plate temperature.

In the fifth step, extrusion of the thermoplastic resin melt through the die plate can be restarted after a passage of time by initiating movement of the extruder.

This method of the invention, like the first aspect, contemplates inducing partial solidification of the resin material in the holes of the die plate by permitting full water to flow across the face of the die plate as if the extruder were still running. By partial solidification, it is meant that the resin material in the holes of the die plate is sufficiently solid (or low in viscosity) to minimize or prevent polymer drool and cooling water from flowing back into the extruder, but not so much as to create too much back-pressure to restart the extrusion.

An advantage of this method of the invention is that the pelletizer can be stopped temporarily for maintenance or trouble-shooting or other reasons, and restarted without the need to reduce and/or increase heating of the die plate, which could be slow and cumbersome to carry out.

This invention can be further illustrated by the following example of preferred embodiments thereof, although it will be understood that the example is included merely for purposes of illustration and are not intended to limit the scope of the invention.

### EXAMPLE

LDPE was melted in a single-screw extruder having a 500 mm diameter, thermally insulated die plate with approximately 1200 holes and 18 rotating pelletizer blades. The die plate is of the type described in U.S. Pat. No. 4,752,196.

Table 1 below shows the die plate steam pressure, polymer melt temperature, pelletizer water flow, pelletizer water temperature, extruder speed, and pelletizer knife speed versus time of an exemplary underwater start-up according to the present invention.

TABLE 1

| | | Polymer | Pellet- | Pellet- | Pellet- | |
|---|---|---|---|---|---|---|
| | Die Plate | Melt | izer | izer | izer | |
| | Steam | Temper- | Water | Water | Knife | Extruder |
| Time | Pressure | ature | Temp. | Flow | Speed | Speed |
| (min.) | (psig) | (° C.) | (° C.) | (gps) | (rpm) | (rpm) |
| 0 | ~430 | ~190 | ~60 | 0 | 0 | 0 |
| 1.5 | ~430 | ~190 | ~60 | started | 0 | 0 |
| 2 | ~410 | ~190 | ~60 | ~26 | started | 0 |
| 5 | ~420 | ~190 | ~60 | ~25 | ~340 | Started |
| 10 | ~425 | ~200 | ~60 | ~26 | ~340 | ~35 |

As seen from Table 1, at time=0, the die plate steam pressure was approximately 430 psig, the polymer melt temperature was about 190° C., and the pelletizer water temperature was about 60° C.

At time=1.5 minutes, cooling water at a temperature of about 60° C. started to flow across the face of the die plate. The extruder speed was set at 0 rpm.

At time=2 minutes, cooling water was flowing at about 26 gallons per second (gps), and the pelletizer blades started to rotate. The extruder speed was still set at 0 rpm.

At time=5 minutes, water has been flowing across the die plate for 3.5 minutes before the extruder was started and polymer flow began.

At time=10 minutes, the extruder speed was about 35 rpm.

The invention has been described in detail with particular reference to preferred embodiments thereof, but it will be understood that variations and modifications can be effected within the spirit and scope of the invention.

I claim:

1. A method for starting up a thermoplastic resin pelletizer, comprising:
(a) providing a thermoplastic resin pelletizer having an internally insulated die plate;
(b) heating a thermoplastic resin melt in the pelletizer to a temperature of Tm+30° C. to Tm+200° C., where Tm is the melt transition temperature of the thermoplastic resin as measured by ASTM D-3418;
(c) heating the die plate to a temperature of Tm+50° C. to Tm+250° C.;
(d) passing water having a temperature between Tm−20° C. to Tm−50° C. across the face of the die plate for an amount of time sufficient to solidify at least a portion of the thermoplastic resin melt in the holes of the die plate before extruding the thermoplastic resin melt through the die plate; and
(e) extruding the thermoplastic resin melt through the die plate.

2. The method according to claim 1, wherein the thermoplastic resin is low density polyethylene.

3. The method according to claim 1, wherein the die plate is heated with steam.

4. The method according to claim 3, wherein the steam has a pressure of about 100 psi to about 600 psi.

5. The method according to claim 1, wherein the water is passed across the face of the die plate for 1 minute to 30 minutes before extruding the thermoplastic resin melt through the die plate.

6. A method for starting up a pelletizer, comprising:
(a) providing a pelletizer having an internally insulated die plate;
(b) heating a low density polyethylene melt in the pelletizer to a temperature between about 230 and 300° C.;
(c) heating the die plate with steam to a temperature between about 225 and 260° C.;
(d) passing water having a temperature between about 60 and 90° C. across the face of the die plate for 1 minute to 30 minutes before extruding the polyethylene melt through the die plate; and
(e) extruding the polyethylene melt through the die plate.

7. The method according to claim 5, wherein the die plate temperature is about 225° C., the polyethylene melt temperature is about 250° C., and the water temperature is about 75° C.

8. A method for stopping and restarting a thermoplastic resin pelletizer having an internally insulated die plate, comprising:
(a) stopping extruding a thermoplastic resin melt through the die plate;
(b) maintaining water flowing across the face of the die plate at a temperature used during extrusion for an amount of time sufficient to solidify at least a portion of the thermoplastic resin melt in the holes of the die plate;
(c) maintaining the thermoplastic resin melt in the pelletizer at a temperature used during extrusion;
(d) maintaining the die plate at a temperature used during extrusion; and
(e) restarting extruding the thermoplastic resin melt through the die plate.

9. The method according to claim 8, wherein the water flowing across the face of the die plate is maintained at a temperature of Tm−20° C. to Tm−50° C., where Tm is the melt transition temperature of the thermoplastic resin as measured by ASTM D-3418.

10. The method according to claim 8, wherein the thermoplastic resin melt in the pelletizer is maintained at a temperature of Tm+30° C. to Tm+200° C.

11. The method according to claim 8, wherein the die plate is maintained at a temperature of Tm+50° C. to Tm+250° C.

12. The method according to claim 8, wherein the thermoplastic resin is low density polyethylene.

13. The method according to claim 8, wherein the die plate is heated with steam.

14. The method according to claim 13, wherein the steam has a pressure of about 100 psi to about 600 psi.

15. The method according to claim 8, wherein water flowing across the face of the die plate is maintained for 1 minute to 30 minutes before restarting extruding the thermoplastic resin melt through the die plate.

16. The method according to claim 8, wherein the pelletizer comprises rotatable blade(s) for cutting extruded thermoplastic resin into pellets and wherein the blade(s) are maintained rotating while the thermoplastic resin melt extruding through the die plate is stopped.
